(19) United States
(12) Patent Application Publication
(10) Pub. No.: US 2009/0230780 A1
(43) Pub. Date: Sep. 17, 2009

(54) Power controller for a mounting substrate and a semiconductor substrate

(75) Inventor: Seisei Oyamada, Tokyo (JP)

Correspondence Address: COLLARD & ROE, P.C., 1077 NORTHERN BOULEVARD, ROSLYN, NY, 11576, US

(73) Assignee: Technology Alliance Group, Inc.

(21) Appl. No.: 12/077,178

(22) Filed: Mar. 17, 2008

(51) Int. Cl. H02B 1/24; H01H 35/00

(52) U.S. Cl. 307/130; 307/112

(57) ABSTRACT

In a power controller for a mounting substrate adapted to mount an integrated circuit includes I/O pads mounted on a semiconductor substrate as the mounting substrate, and a Vcc1 electric circuit system mounted on the semiconductor substrate, an isolator portion is included in the power controller and is connected between one of the I/O pads and the Vcc1 electric circuit system. Another isolator portion may be connected between the other I/O pad and another Vcc3 electric circuit system.

### BACKGROUND OF THE INVENTION

This invention relates to a power controller for a mounting substrate and a semiconductor substrate and, in particular, to a power controller for a mounting substrate, which is capable of achieving low power consumption by preventing occurrence of a leak current, and a semiconductor substrate.

In a semiconductor integrated circuit, it is an important object to achieve low power consumption by preventing occurrence of a leak current (for example, see Japanese Unexamined Patent Application Publication (JP-A) No. 2004-228417). Referring to FIG. 1A, a power supply system for a LSI mounting substrate will be described. In the figure, an organic substrate 501 is provided with I/O pads 511 and 516 formed thereon. On the organic substrate 501, LSI bare chips 520 and 530 are connected in series between the I/O pads 511 and 516. Each of electric circuits 521 and 531 comprises CMOS inverters which may be represented by bidirectional transceivers between input and output terminals.

The LSI bare chip 520 has pads 522 and 523 connected to pads 512 and 513 of the organic substrate 501 through solder balls HB, respectively. The LSI bare chip 530 has pads 532 and 533 connected to pads 514 and 515 of the organic substrate 501 through bonding wires BW, respectively. A pair of the pads 511 and the 512, the pads 513 and 514, and the pads 515 and 516 is electrically connected to each other, as symbolized by a real line in FIG. 1.

Referring to FIG. 1B, an equivalent circuit of the LSI mounting substrate in FIG. 1A is illustrated. In the illustrated LSI mounting substrate, when a block is in a temporarily inactive state, power supply is shuts down in order to achieve low power consumption. The structure completely prevents occurrence of a leak current from the block. For example, on the input side, use is made of the technique of separating or removing, in the LSI bare chips 520 and 530 mounted to the organic substrate 501, an input ESD protection diode to separate paths from the input side. On the output side, use is made of the technique of floating a gate of a PMOS (providing a floating gate 550) from ground to block a path between a source and a drain.

However, in the floating gate, when a “high” level appears at the output side, a “high impedance” is kept in terms of DC. However, if an AC pulse input is supplied, a path is temporarily formed to cause a leak current to flow. It is therefore impossible to achieve sufficiently low power consumption.

### SUMMARY OF THE INVENTION

In view of the above, it is an object of this invention to provide a power controller for a mounting substrate, which is capable of achieving low power consumption by completely shutting off an external input, and to provide a semiconductor substrate.

According to this invention, there is provided a power controller for a mounting substrate for mounting an integrated circuit, wherein the mounting substrate is a semiconductor substrate. The power controller comprises an I/O mounted to the semiconductor substrate; one or a plurality of electric circuits mounted to the semiconductor substrate; and an isolator portion including a transfer gate, connected between the I/O and each electric circuit, and formed in the semiconductor substrate.

Preferably, the power controller further comprises a monitoring circuit for monitoring a power supply voltage of the electric circuit to controllably open and close the transfer gate of the isolator portion.

Preferably, the electric circuits are connected to the isolator portions, respectively. The monitoring circuit detects the power supply voltage of the electric circuits, compares the power supply voltages with a predetermined threshold value and, when at least one of the power supply voltages becomes equal to or lower than the predetermined threshold value, closes the transfer gates of all of the isolator portions.

Preferably, the electric circuits are connected to the isolator portions, respectively. The monitoring circuit detects the power supply voltages of the electric circuits, compares the power supply voltages and threshold values individually determined for the respective electric circuits, and controllably opens and closes the transfer gates of the isolator portions.

It is preferable that, when the transfer gates of the isolator portions are controllably opened and closed, delay times are determined between start times of operation.

According to this invention, there is also provided a semiconductor substrate for mounting an integrated circuit, wherein an isolator portion including a transfer gate is formed between each I/O and an electric circuit.

According to this invention, in a power controller for a mounting substrate for mounting an integrated circuit, the mounting substrate is a semiconductor substrate. The power controller comprises an I/O mounted to the semiconductor substrate; one or a plurality of electric circuits mounted to the semiconductor substrate; and an isolator portion including a transfer gate, connected between the I/O and each electric circuit, and formed in the semiconductor substrate. Therefore, the isolator portion formed in the semiconductor substrate completely blocks an external voltage or an external pulse input to prevent occurrence of a leak current. Thus, it is possible to provide a power controller for a mounting substrate, which is capable of achieving low power consumption.

### BRIEF DESCRIPTION OF THE DRAWINGS

FIG. 1A is a schematic view showing a power supply system for an LSI mounting substrate;

FIG. 1B is a view showing an equivalent circuit of the LSI mounting substrate illustrated in FIG. 1A;

FIG. 2A is a schematic view showing a power supply system for a mounting substrate according to a first embodiment of this invention;

FIG. 2B is a schematic circuit diagram of the power supply system illustrated in FIG. 2A;

FIG. 2C is a timing chart for describing an operation of the power supply system illustrated in FIG. 2B;

FIG. 3A is a schematic circuit diagram of a power supply system for a mounting substrate according to a second embodiment of this invention;

FIG. 3B is a timing chart for describing an operation of the power supply system illustrated in FIG. 3A;

FIG. 4A is a schematic view showing a power supply system for a mounting substrate according to a third embodiment of this invention;

FIG. 4B is a schematic circuit diagram of the power supply system illustrated in FIG. 4A;

FIG. 4C is a timing chart for describing an operation of the power supply system illustrated in FIG. 4B;

FIG. 5A is a schematic circuit diagram of a power supply system for a mounting substrate according to a fourth embodiment of this invention; and

FIG. 5B is a timing chart for describing an operation of the power supply system illustrated in FIG. 5A.

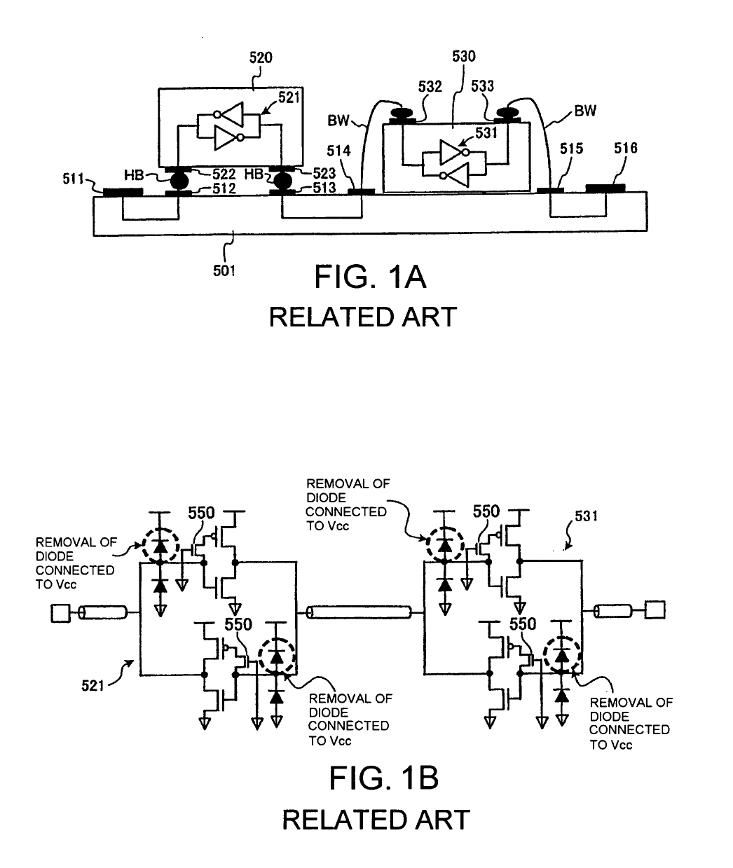

### DESCRIPTION OF THE EXEMPLARY EMBODIMENTS

Now, several exemplary embodiments of this invention will be described with reference to the drawing. It is noted here that this invention is not limited to the following embodiments. Components in the following embodiments encompass those which are readily envisaged by a skilled person or those which are substantially equivalent.

In a power controller for a mounting substrate according to this invention, a transfer gate as an isolator portion is arranged in a semiconductor substrate to block an external voltage or an external pulse input from the outside of a system so that a leak current is prevented. Thus, low power consumption is achieved.

### First Embodiment

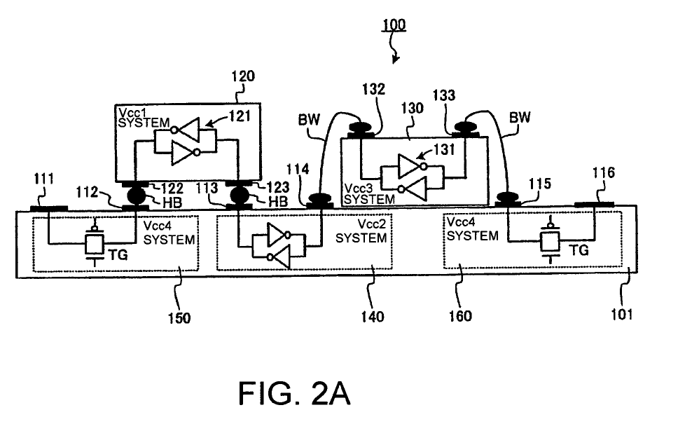

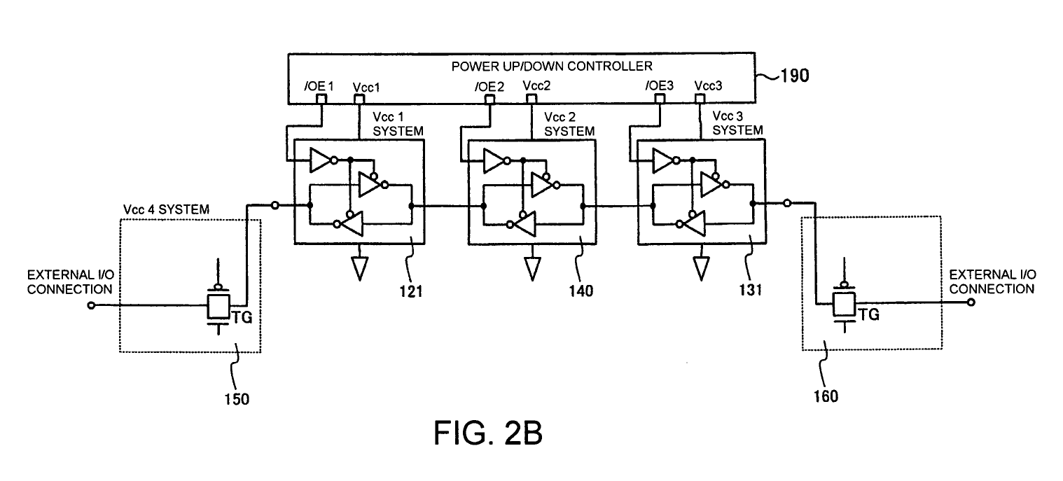

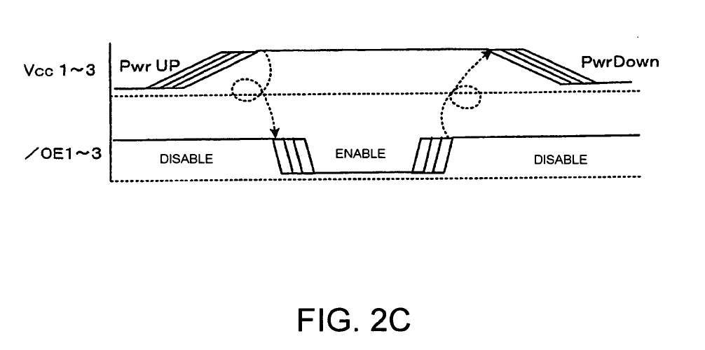

Referring to FIGS. 2A to 2C, description will be made of a power supply system for a mounting substrate according to a first embodiment of this invention. As illustrated in FIG. 2A, a silicon substrate 101 which is typical of a semiconductor substrate is provided with I/O pads 111 and 116 formed thereon.

On the illustrated silicon substrate 101, LSI bare chips 120 and 130 are mounted. The LSI bare chips 120 and 130 comprise a Vcc1 electric circuit system 121 and a Vcc3 electric circuit system 131 which will be simply called a Vcc1 system and Vcc3 system, respectively. Each of the illustrated systems 121 and 131 is featured by bidirectional transceivers formed by inverters each of which may be implemented by CMOS transistors.

In the illustrated silicon substrate 101, a plurality of Vcc4 electric circuit systems, namely, Vcc4 systems 150, and 160 are formed together with the Vcc2 system 140. The illustrated Vcc4 systems 150 and 160 are specified only by isolator portions and may therefore be called Vcc4 isolator portions 150 and 160, respectively. The Vcc4 isolator portion 150 comprises a transfer gate TG and serves to block an input from the I/O pad 111. The Vcc4 isolator portion 160 comprises a transfer gate TG and serves to block an input from the I/O pad 116. The Vcc2 electric circuit system 140 comprises inverters which are formed by CMOS transistors and which are configured into bidirectional transceivers. The Vcc2 electric circuit system 140 is used as a power supply circuit for a facilitator circuit for the LSI bare chips 120 and 130 and as an embedded circuit having a particular function like the LSI bare chips 120 and 130.

Between the I/O pads 111 and 116, the Vcc4 isolator portion 150, the Vcc1 electric circuit 121, the Vcc2 electric circuit 140, the Vcc3 electric circuit 131, and the Vcc4 isolator portion 160 are electrically connected in series.

The LSI bare chip 120 has pads 122 and 123 connected via solder balls HB to pads 112 and 113 formed on the semiconductor substrate 101. The LSI bare chip 130 has pads 132 and 133 connected via bonding wires BW to pads 114 and 115 formed on the semiconductor substrate 101.

Referring to FIG. 2B, a power up/down controller 190 controls operations of the Vcc1 electric circuit system 121, the Vcc2 electric circuit system 140, and the Vcc3 electric circuit system 131 all of which are simply represented by Vcc1 system, Vcc2 system, and Vcc3 system in FIG. 2B. Specifically, as illustrated in FIG. 2C, the power up/down controller 190 produces a power supply control signal (represented by Vcc1, Vcc2, Vcc3) for increasing or decreasing power (namely, power up or power down) and a drive signal (/OE1, /OE2, /OE3) for permitting or inhibiting the operation and transmits these signals to the Vcc1 electric circuit system 121, the Vcc2 electric circuit system 140, and the Vcc3 electric circuit system 131. The power up/down controller 190 is arranged inside or outside the semiconductor substrate 101.

As illustrated in FIG. 2C, each of the Vcc1 to Vcc3 systems 121, 140, 131 is put into an enable state by each of the drive signals /OE1 to /OE3 after supply of the power supply control signal.

Each of the Vcc4 isolator portions 150 and 160 is continuously energized and the transfer gate TG thereof is kept in a high impedance state. The Vcc4 isolator portion 150 blocks input of an external voltage or an external pulse from the outside via the I/O pad 111 (FIG. 2A) to the Vcc1 electric circuit system 121. The Vcc4 isolator portion 160 blocks input of an external voltage or an external pulse from the outside via the I/O pad 116 to the Vcc3 electric circuit system 131.

As described above, according to the first embodiment, the isolator portions including the above-mentioned type of the transfer gate are formed in the semiconductor substrate. Each of the isolator portions is connected between each I/O and each electric circuit. Therefore, it is possible to completely block input of an external voltage or an external pulse to prevent occurrence of a leak current. As a consequence, low power consumption is achieved.

### Second Embodiment

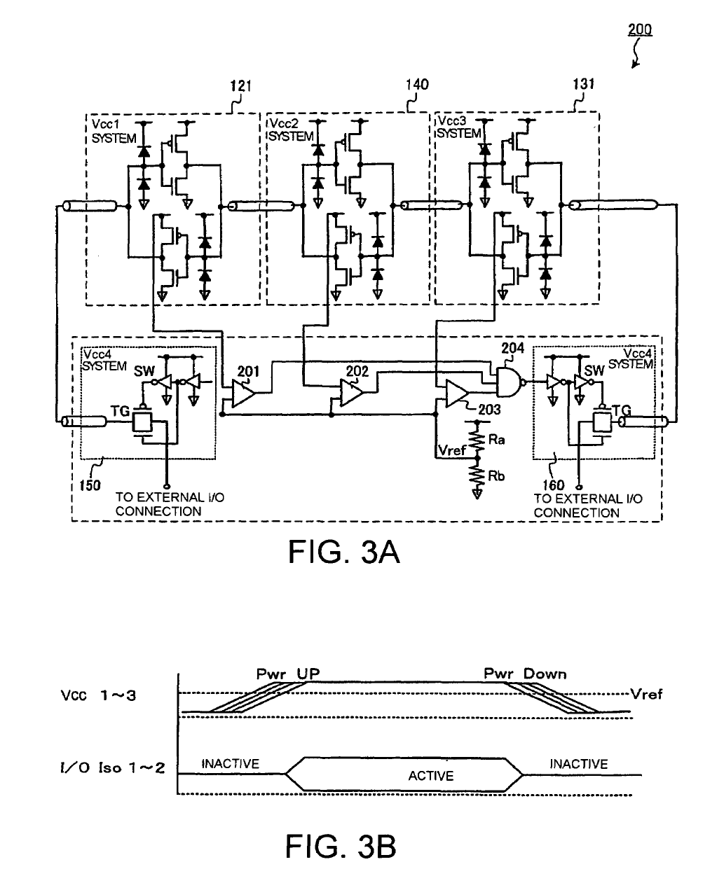

Referring to FIGS. 3A and 3B, description will be made of a power supply system for a mounting substrate according to a second embodiment of this invention. The power supply system for a mounting substrate according to the second embodiment is different from the first embodiment in that power supply voltages of the Vcc1 electric circuit system 121, the Vcc2 electric circuit system 140, and the Vcc3 electric circuit system 131 are monitored to controllably open and close the transfer gates TG of the Vcc4 isolator portions 150 and 160. In FIG. 3A, parts equivalent in function to those in FIG. 2B are designated by like reference numerals. In FIG. 3A, the power up/down controller 190 is not illustrated for simplicity of illustration.

Referring to FIG. 3A, the power supply system 200 for a mounting substrate according to the second embodiment comprises a monitoring circuit for monitoring the power supply voltages of the Vcc1 electric circuit system 121, the Vcc2 electric circuit system 140, and the Vcc3 electric circuit system 131 to controllably open and close the transfer gates of the Vcc4 isolator portions 150 (I/OIso1) and 160 (I/OIso2).

The monitoring circuit comprises comparators 201, 202, and 203, a NAND gate 204, and reference resistors Ra and Rb for producing a reference voltage Vref. The comparators 201, 202, and 203 have first input terminals connected to sources of PMOS transistors of inverter circuits in the Vcc1 electric circuit system 121, the Vcc2 electric circuit system 140, and the Vcc3 electric circuit system 131, respectively, second input terminals connected in common to a junction of the reference resistors Ra and Rb, and output terminals connected to input terminals of the NAND gate 204. The NAND gate 204 is connected to both of the Vcc4 isolator portions 150 and 160, although the illustrated NAND gate 204 is connected only to the Vcc4 isolator portion 160. Specifically, the NAND gate 204 has an output terminal connected to inverters SW of the Vcc4 isolator portions 150 and 160. The comparators 201, 202, and 203 compare each of the power supply voltages supplied from the PMOS transistors of the Vcc1 electric circuit system 121, the Vcc2 electric circuit system 140, and the Vcc3 electric circuit system 131 with the reference voltage Vref. When each power supply voltage is higher than the reference voltage Vref, each of the comparators 201, 202, and 203 produces a “high” level. When the power supply voltage is not higher than the reference voltage Vref, each of the comparators 201, 202, and 203 produces a “low” level.

When at least one of inputs of the comparators 201, 202, and 203 has a “low” level, the NAND gate 204 produces a “high” level which is supplied to the inverters SW of the Vcc4 isolator portions 150 and 160. Supplied with the “high” level from the NAND gate 204, each of the inverters SW of the Vcc4 isolator portions 150 and 160 closes the transfer gate TG (high impedance state). As a result, the Vcc1, the Vcc2, and the Vcc3 electric circuit systems 121, 140, and 131 are shut down. Thus, when the power supply voltage of at least one of the Vcc1, the Vcc2, and the Vcc3 electric circuit systems 121, 140, and 131 becomes equal to or lower than the reference voltage Vref as illustrated in FIG. 3B, the transfer gates TC (inactive) of the Vcc4 isolator portion 150 (IOIso1) and the Vcc4 isolator portion 160 (IOIso2) are closed under control of the monitoring circuit to shut off an external path.

According to the second embodiment, the power supply voltages of the Vcc1 electric circuit system 121, the Vcc2 electric circuit system 140, and the Vcc3 electric circuit system 131 are monitored to controllably open and close the transfer gates TG of the Vcc4 isolator portions 150 and 160. Therefore, it is possible to control the operation of the transfer gates TG with reference to the power supply voltages of the Vcc1 electric circuit system 121, the Vcc2 electric circuit system 140, and the Vcc3 electric circuit system 131.

### Third Embodiment

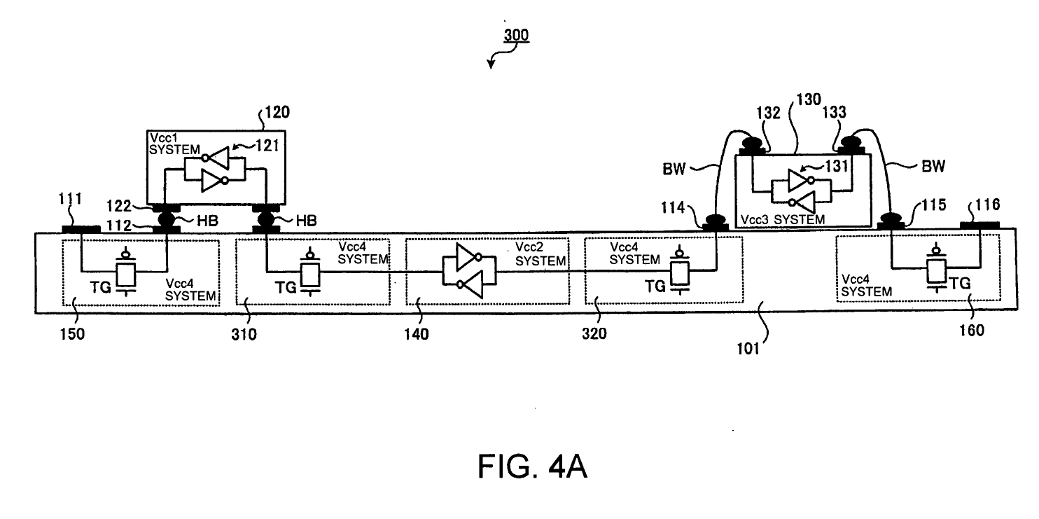

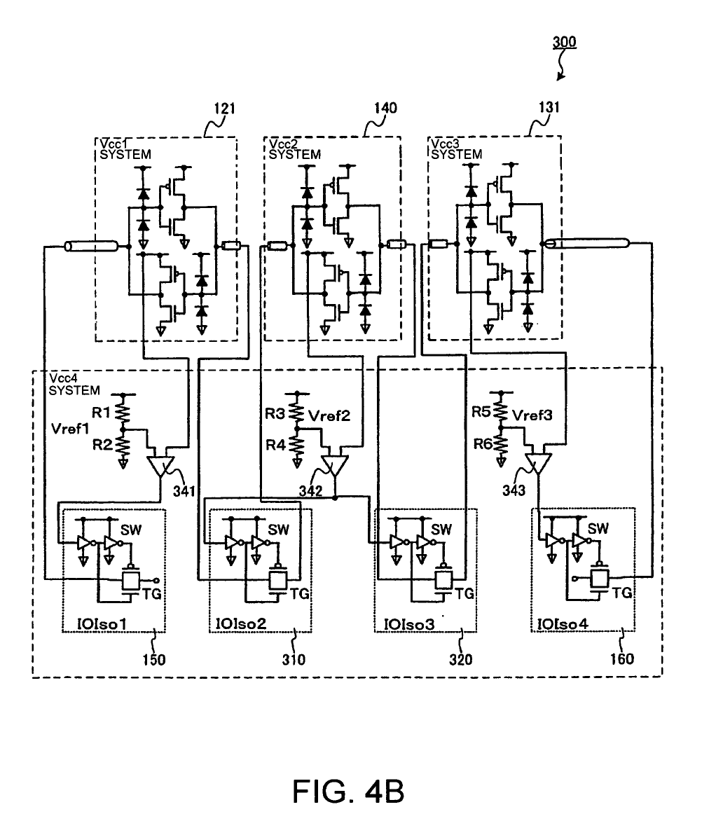

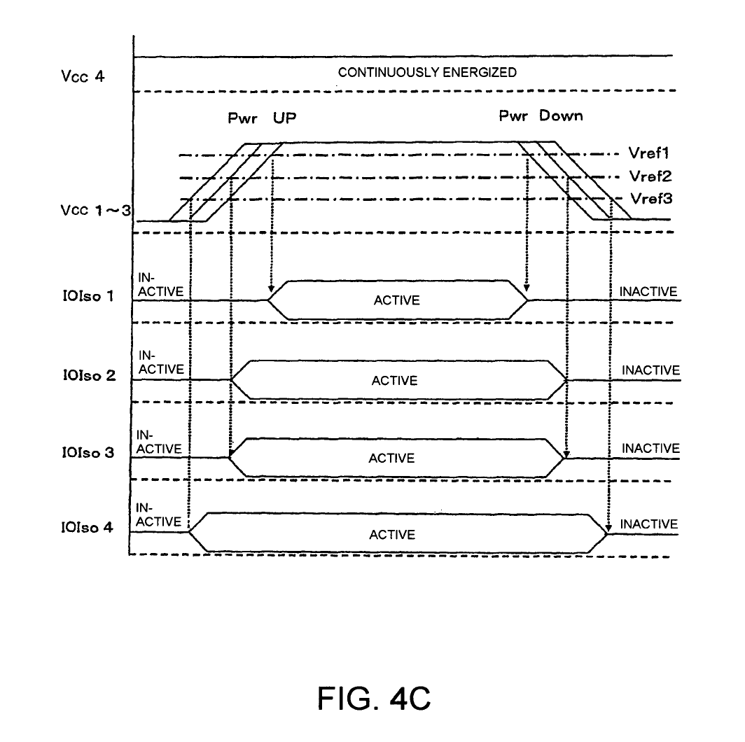

Referring to FIGS. 4A to 4C, description will be made of a power supply system for a mounting substrate according to a third embodiment of this invention. In the power supply system for a mounting substrate according to the second embodiment, the monitoring circuit compares one reference voltage with each of the power supply voltages. On the other hand, in the power supply system for a mounting substrate according to the third embodiment, the monitoring circuit determines individual reference voltages for the respective electric circuits and compares the individual reference voltages and the respective power supply voltages to controllably open and close the transfer gates of the isolator portions.

In FIG. 4A, parts equivalent in function to those in FIG. 2A are designated by like reference numerals. In FIG. 4B, parts equivalent in function to those in FIG. 3A are designated by like reference numerals. For simplicity of illustration, the power up/down controller 190 is not illustrated in FIG. 4B.

As illustrated in FIG. 4A, the power supply system 300 for a mounting substrate according to the third embodiment is different from the power supply system 100 according to the first embodiment in that a Vcc4 isolator portion 310 is connected between the Vcc1 electric circuit 121 and the Vcc2 electric circuit 140 and a Vcc4 isolator portion 320 is connected between the Vcc2 electric circuit system 140 and the Vcc3 electric circuit system 131.

Referring to FIG. 4B, a monitoring circuit comprises comparators 341, 342, and 343, reference resistors R1 and R2 for producing a reference voltage Vref1, reference resistors R3 and R4 for producing a reference voltage Vref2, and reference resistors R5 and R6 for producing a reference voltage Vref3.

The comparator 341 has a first input terminal connected to the source of the PMOS transistor forming the inverter circuit of the Vcc1 electric circuit system 121, a second input terminal connected to a junction of the reference registers R1 and R2, and an output terminal connected to the inverter SW of the Vcc4 isolator portion 150. The comparator 341 compares the power supply voltage supplied to the PMOS transistor of the Vcc1 electric circuit system 121 with the reference voltage Vref 1 and, when the power supply voltage is higher than and not higher than the reference voltage Vref1, produces a “low” level and a “high” level, respectively, to be supplied to the inverter Sw of the Vcc4 isolator portion 150.

Supplied with the “high” level from the comparator 341, the inverter SW of the Vcc4 isolator portion 150 (IOIso1) closes the transfer gate TG. Specifically, when the Vcc1 electric circuit 121 is shut down and the power supply voltage becomes equal to or lower than the reference voltage Vref1, the transfer gate TG of the Vcc4 isolator portion 150 is closed to shut off an external path to the Vcc1 electric circuit 121 (see FIG. 4C).

The comparator 342 has a first input terminal connected to the source of the PMOS transistor forming the inverter circuit of the Vcc2 electric circuit system 140, a second input terminal connected to a junction of the reference resistors R3 and R4, and an output terminal connected to the inverters SW of the Vcc4 isolator portions 310 and 320. The comparator 342 compares the power supply voltage supplied to the PMOS transistor of the Vcc2 electric circuit 140 with the reference voltage Vref 2 and, when the power supply voltage is higher than and not higher than the reference voltage Vref2, produces a “low” level and a “high” level, respectively, to be supplied to inverters SW of the Vcc4 isolator portions 310 and 320.

Supplied with the “high” level from the comparator 342, the inverters SW of the Vcc4 isolator portions 310 and 320 close the transfer gates TG. Specifically, when the Vcc2 electric circuit system 140 is shut down and the power supply voltage becomes equal to or lower than the reference voltage Vref2, the transfer gates TG of the Vcc4 isolator portions 310 (IOIso2) and 320 (IOIso3) are individually closed to shut off paths from the outside to the Vcc1 electric circuit 1 system 21, the Vcc2 electric circuit system 140, and the Vcc3 electric circuit system 131 in a manner illustrated in FIG. 4C.

The comparator 343 has a first input terminal connected to the source of the PMOS transistor forming the inverter circuit of the Vcc3 electric circuit 131, a second input terminal connected to a junction of the reference resistors R5 and R6, and an output terminal connected to the inverter SW of the Vcc4 isolator portion 160. The comparator 343 compares the power supply voltage supplied to the PMOS transistor of the Vcc3 electric circuit 131 with the reference voltage Vref 3 and, when the power supply voltage is higher than and not higher than the reference voltage Vref3, produces a “low” level and a “high” level, respectively, to be supplied to the inverter SW of the Vcc4 isolator portion 160.

Supplied with the “high” level from the comparator 343, the inverter SW of the Vcc4 isolator portion 160 closes the transfer gate TG. Specifically, when the Vcc3 electric circuit 131 is shut down and the power supply voltage becomes equal to or lower than the reference voltage Vref3, the transfer gate TG of the Vcc4 isolator portion 160 (IOIso4) is closed to shut off an external path to the Vcc3 electric circuit 131 (see FIG. 4C).

According to the third embodiment, the individual reference voltages are determined for the respective electric circuits and compared with the respective power supply voltages. With reference to the result of comparison, the transfer gates TG of the isolator portions are controllably opened and closed. Thus, it is possible to control the isolator portion for each electric circuit.

### Fourth Embodiment

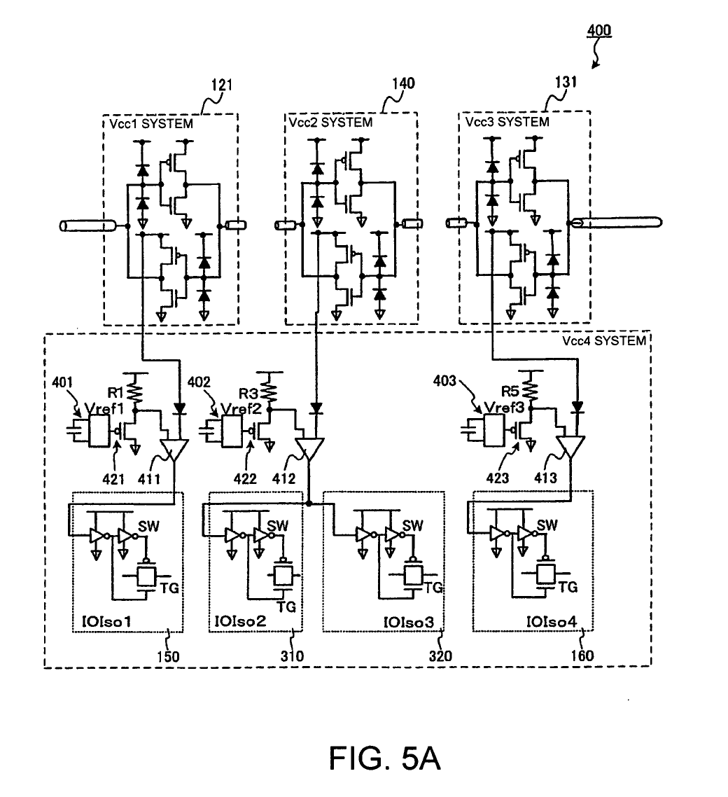

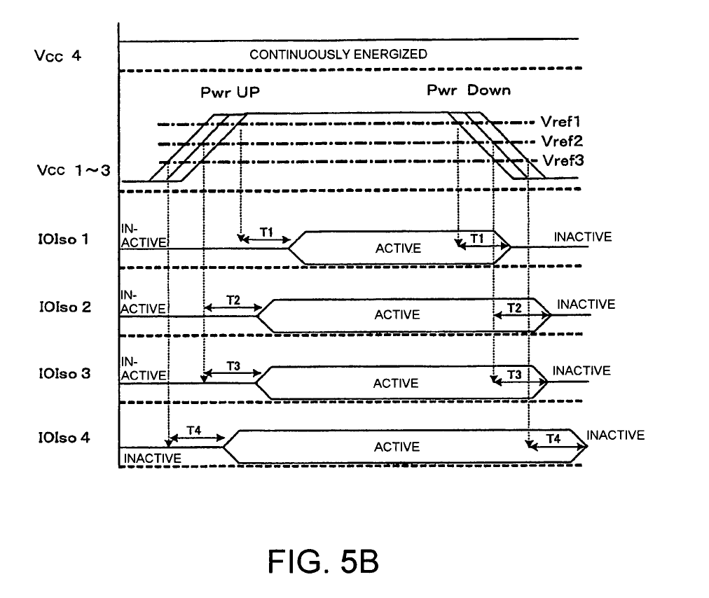

Referring to FIGS. 5A and 5B, description will be made of a power supply system for a mounting substrate according to a fourth embodiment of this invention. The power supply system according to the fourth embodiment is different from the third embodiment in that, when the transfer gates of the isolator portions are controllably opened and closed, a time difference (time delay) is given between start times of operations. In FIG. 5A, parts equivalent in function to those in FIG. 4B are designated by like reference numerals.

Referring to FIG. 5A, a MOS transistor 421 is connected between GND and the reference resistor R1 connected to a Vcc power source (not shown in FIG. 5A). The MOS transistor 421 has a gate connected to a one-shot multivibrator 401 oscillating in a time cycle T1. Thus, as illustrated in FIG. 5B, the Vcc4 isolator portion 150 (IOIso1) opens the transfer gate TG after lapse of a time interval T1 after the power supply voltage of the Vcc1 electric circuit 121 becomes greater than the reference voltage Vref1 and closes the transfer gate TG after lapse of the time interval T1 after the power supply voltage of the Vcc1 electric circuit 121 becomes equal to or lower than the reference voltage Vref1.

Similarly, referring to FIG. 5A, a MOS transistor 422 is connected between GND and the reference resistor R3 connected to Vcc. The MOS transistor 422 has a gate connected to a one-shot multivibrator 402 oscillating in a time cycle T2 (=T3). Thus, as illustrated in FIG. 5B, the Vcc4 isolator portions 310 and 320 (IOIso2 and IOIso3) open the transfer gates TG after lapse of a time interval T2 after the power supply voltage of the Vcc2 electric circuit 140 becomes higher than the reference voltage Vref2 and closes the transfer gates TG after lapse of the time interval T2 after the power supply voltage of the Vcc2 electric circuit 140 becomes equal to or lower than the reference voltage Vref2.

Referring to FIG. 5A, a MOS transistor 423 is connected between GND and the reference resistor R5 connected to Vcc. The MOS transistor 423 has a gate connected to a one-shot multivibrator 403 oscillating in a time cycle T4. Thus, as illustrated in FIG. 5B, the Vcc4 isolator portion 160 (IOIso4) opens the transfer gate TG after lapse of a time interval T4 after the power supply voltage of the Vcc3 electric circuit 131 becomes higher than the reference voltage Vref 3 and closes the transfer gate TG after lapse of the time interval T4 after the power supply voltage of the Vcc electric circuit 131 becomes equal to or lower than the reference voltage Vref3.

According to the fourth embodiment, delay times are determined when the transfer gates of the isolator portions are controllably opened and closed. Therefore, the fourth embodiment is effective in case where a plurality of electric circuits must be controlled sequentially with time differences.

As mentioned above, the power source circuit system, such as the Vcc1 system, and the like is connected to the power controller which includes the isolator portion for allowing only one way directional path and for rejecting a reverse directional path. Therefore, the power controller for a mounting substrate according to this invention is useful in order to achieve low power consumption of an integrated circuit mounted on a mounting substrate.

Although this invention has been described in conjunction with the exemplary embodiments thereof, this invention is not limited to the foregoing embodiments but may be modified in various other manners within the scope of the appended claims.

1: A power controller for a mounting substrate for mounting an integrated circuit, wherein:
the mounting substrate is a semiconductor substrate;
the power controller comprising:
an I/O mounted to the semiconductor substrate;
one or a plurality of electric circuits mounted to the semiconductor substrate; and
an isolator portion including a transfer gate, connected between the I/O and each electric circuit, and formed in the semiconductor substrate.

2: The power controller according to claim 1, further comprising a monitoring circuit for monitoring a power supply voltage of the electric circuit to controllably open and close the transfer gate of the isolator portion.

3: The power controller according to claim 2, wherein:
the electric circuits are connected to the isolator portions, respectively; and
the monitoring circuit detects the power supply voltage of the electric circuits, compares the power supply voltages with a predetermined threshold value and, when at least one of the power supply voltages becomes equal to or lower than the predetermined threshold value, closes the transfer gates of all of the isolator portions.

4: The power controller according to claim 2, wherein:
the electric circuits are connected to the isolator portions, respectively; and
the monitoring circuit detects the power supply voltages of the electric circuits, compares the power supply voltages and threshold values individually determined for the respective electric circuits, and controllably opens and closes the transfer gates of the isolator portions.

5: The power controller according to claim 3, wherein, when the transfer gates of the isolator portions are controllably opened and closed, delay times are determined between start times of operation.

6: A semiconductor substrate for mounting an integrated circuit, wherein an isolator portion including a transfer gate is formed between each 10 and an electric circuit.
